(19) United States
(12) Patent Application Publication
(10) Pub. No.: US 2025/0178350 A1
(43) Pub. Date: Jun. 5, 2025

(54) LIQUID SUPPLY DEVICE AND INKJET RECORDING APPARATUS

(71) Applicant: KYOCERA Document Solutions Inc., Osaka (JP)

(72) Inventors: Yasutaka INUI, Osaka-shi (JP); Shuhei KAWAMATA, Osaka-shi (JP)

(73) Assignee: KYOCERA Document Solutions Inc., Osaka (JP)

(21) Appl. No.: 18/964,919

(22) Filed: Dec. 2, 2024

(30) Foreign Application Priority Data
Dec. 5, 2023 (JP) 2023-205630

(51) Int. Cl. B41J 2/165

(52) U.S. Cl. CPC B41J 2/16552

(57) ABSTRACT

A liquid supply device includes a flow pass, a pump, and an opening/closing device. The pump supplies a liquid to the flow pass. The opening/closing device opens and closes the flow pass. The flow pass includes a plurality of distribution flow passes provided in parallel between the pump and the opening/closing device. Each of the distribution flow passes includes a blanch flow pass, a filter, and a check valve. The branch flow pass is branched from the distribution flow pass. The filter filters the liquid flowing in the distribution flow pass. The check valve is provided on a downstream side of the filter. In each of the distribution flow passes, a flow resistance of the filter is larger than a release pressure of the check valve and a flow resistance of the distribution flow pass when the flow pass is opened by the opening/closing device.

### INCORPORATION BY REFERENCE

This application is based on and claims the benefit of priority from Japanese patent application No. 2023-205630 filed on Dec. 5, 2023, which is incorporated by reference in its entirety.

### BACKGROUND

The present disclosure relates to a liquid supply device and an inkjet recording apparatus.

In an inkjet recording apparatus, during a period when an image forming job is not executed, water evaporates from ink in a nozzle of an inkjet head and the nozzle is clogged due to an increase in viscosity of the ink. To prevent the clogging, the ink in the nozzle is purged to a cap. However, if the ink remaining on a nozzle surface is left, there is a problem that the ink falls on a sheet during the execution of the image forming job or the ink sticks to the nozzle surface. Therefore, a technique for removing the ink remaining on the nozzle surface has been studied. For example, a configuration has been proposed in which the ink is removed from the nozzle surface by sliding a blade in contact with the nozzle surface.

In the above configuration, a cleaning liquid is supplied to a plurality of the inkjet heads through tubes provided in parallel, but if it is left in a state where a flow of the cleaning liquid is stopped for a long period of time, bubbles may be generated in the cleaning liquid in the tubes. If the bubbles are contained in the cleaning liquid, an amount of the cleaning liquid supplied to the inkjet heads may be uneven, or the cleaning liquid may swell into a balloon shape due to the viscosity of the cleaning liquid and then scatter.

As a countermeasure against the bubbles, a configuration is known which includes a bubble trap for catching the bubbles by using buoyancy acting on the bubbles, and a check valve for discharging air accumulated in the bubble trap. However, when the above configuration is provided in each of the parallel tubes, since there is an individual difference in a release pressure of the check valve, when a pressure is applied to the cleaning liquid, a flow of the cleaning liquid may be biased toward the check valve having a low release pressure.

### SUMMARY

A liquid supply device according to the present disclosure includes a flow pass, a pump, and an opening/closing device. The pump supplies a liquid to the flow pass. The opening/closing device opens and closes the flow pass. The flow pass includes a plurality of distribution flow passes provided in parallel between the pump and the opening/closing device. Each of the distribution flow passes includes a blanch flow pass, a filter, and a check valve. The branch flow pass is branched from the distribution flow pass. The filter filters the liquid flowing in the distribution flow pass. The check valve is provided on a downstream side of the filter. In each of the distribution flow passes, a flow resistance of the filter is larger than a release pressure of the check valve and a flow resistance of the distribution flow pass when the flow pass is opened by the opening/closing device.

An inkjet recording apparatus according to the present disclosure includes an inkjet head, the liquid supply device according, and a maintenance device which cleans the inkjet head using the liquid supplied from the liquid supply device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to one embodiment of the present disclosure.

FIG. 2 is a front view schematically showing an internal configuration of an inkjet recording apparatus according to the embodiment of the present disclosure.

FIG. 3 is a front view schematically showing a head unit and a maintenance device according to the embodiment of the present disclosure.

FIG. 4 is a plan view schematically showing the head unit and a wipe unit according to the embodiment of the present disclosure.

FIG. 5 is a plan view schematically showing a cap unit according to the embodiment of the present disclosure.

FIG. 6 is a cross-sectional view showing an inkjet head according to the embodiment of the present disclosure.

FIG. 7 is a perspective view showing the wipe unit and a cleaning liquid supply source according to the embodiment of the present disclosure.

FIG. 8 is a perspective view showing the wipe unit according to the embodiment of the present disclosure.

FIG. 9 is a perspective view showing a blade unit according to the embodiment of the present disclosure.

FIG. 10 is a perspective view showing a cross section of the blade unit according to the embodiment of the present disclosure.

FIG. 11 is perspective view showing a protruding member and a blade according to the embodiment of the present disclosure.

FIG. 12 is a perspective view showing the protruding member according to the embodiment of the present disclosure.

FIG. 13 is a perspective view showing a receiving member according to the embodiment of the present disclosure.

FIG. 14 is a perspective view showing the receiving member according to the embodiment of the present disclosure.

FIG. 15 is a perspective views showing a cleaning liquid supply part and the blade unit according to the embodiment of the present disclosure.

FIG. 16 is a right side view showing the cleaning liquid supply part and the blade unit according to the embodiment of the present disclosure.

FIG. 17 is a right side view showing the cleaning liquid supply part and the blade unit according to the embodiment of the present disclosure.

FIG. 18 is a perspective view showing the cleaning liquid supply part according to the embodiment of the present disclosure.

FIG. 19 is a perspective view showing cross sections of the cleaning liquid supply part and the cleaning liquid supply source according to the embodiment of the present disclosure.

FIG. 20 is a perspective views showing cross sections of the cleaning liquid supply part and the cleaning liquid supply source according to the embodiment of the present disclosure.

FIG. 21 is a perspective view showing cross sections of the cleaning liquid supply part and the cleaning liquid supply source according to the embodiment of the present disclosure.

FIG. 22 is a perspective view showing cross sections of the cleaning liquid supply part and the cleaning liquid supply source according to the embodiment of the present disclosure.

FIG. 23A to FIG. 23G are front view explaining an operation of the maintenance device according to the embodiment of the present disclosure.

FIG. 24A to FIG. 24D are plan view explaining an operation of the wipe unit according to the embodiment of the present disclosure.

FIG. 25 is a right side views explaining the operation of the wipe unit according to the embodiment of the present disclosure.

FIG. 26 is a right side views explaining the operation of the wipe unit according to the embodiment of the present disclosure.

FIG. 27 is a right side views explaining the operation of the wipe unit according to the embodiment of the present disclosure.

FIG. 28 is a right side views explaining the operation of the wipe unit according to the embodiment of the present disclosure.

FIG. 29 is a right side views explaining the operation of the wipe unit according to the embodiment of the present disclosure.

FIG. 30 is a right side views explaining the operation of the wipe unit according to the embodiment of the present disclosure.

FIG. 31 is a plan views showing the cleaning liquid supply source according to the embodiment of the present disclosure.

FIG. 32 is a cross-sectional view showing a check valve according to the embodiment of the present disclosure.

FIG. 33 is a piping system diagram showing the cleaning liquid supply source according to the embodiment of the present disclosure.

FIG. 34 is a piping system diagram showing the cleaning liquid supply source according to a first modified example of the embodiment of the present disclosure.

FIG. 35 is a piping system diagram showing the cleaning liquid supply source according to a second modified example of the embodiment of the present disclosure.

### DETAILED DESCRIPTION

Hereinafter, with reference to the drawings, an inkjet recording apparatus 1 according to one embodiment of the present embodiment will be described.

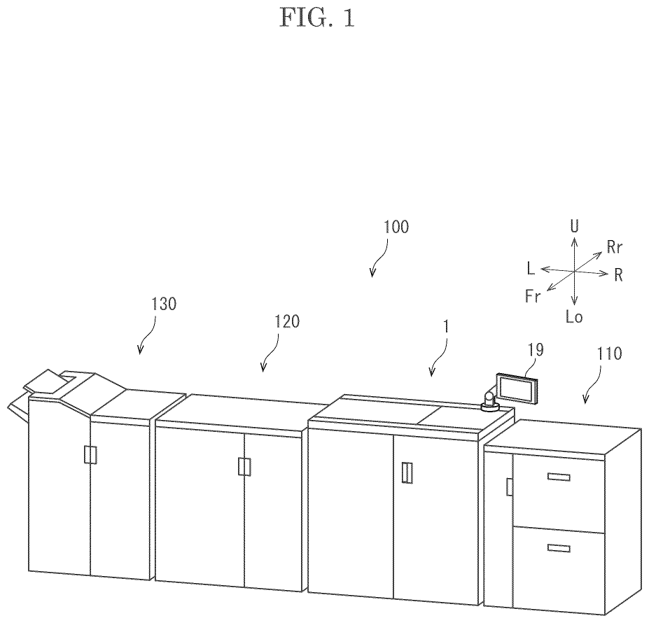

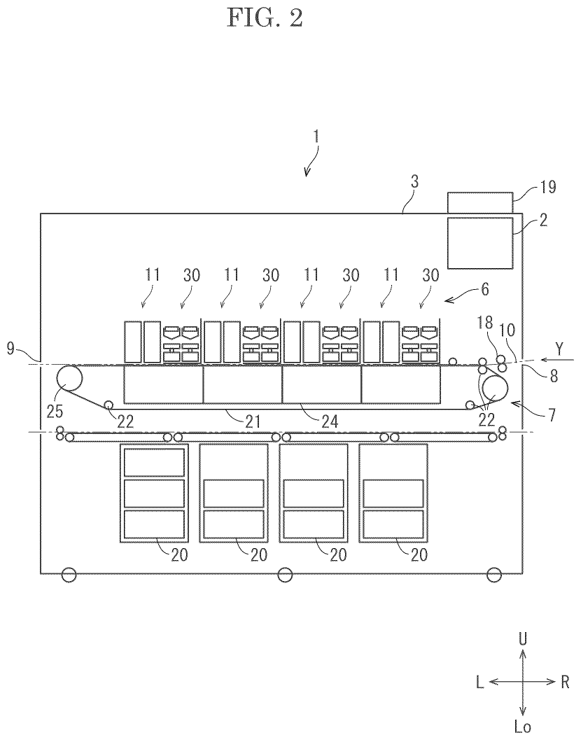

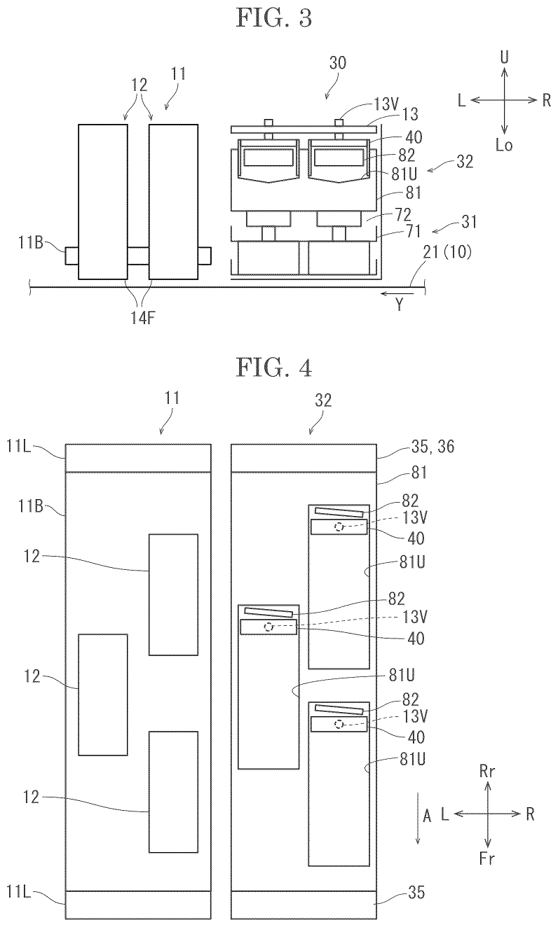

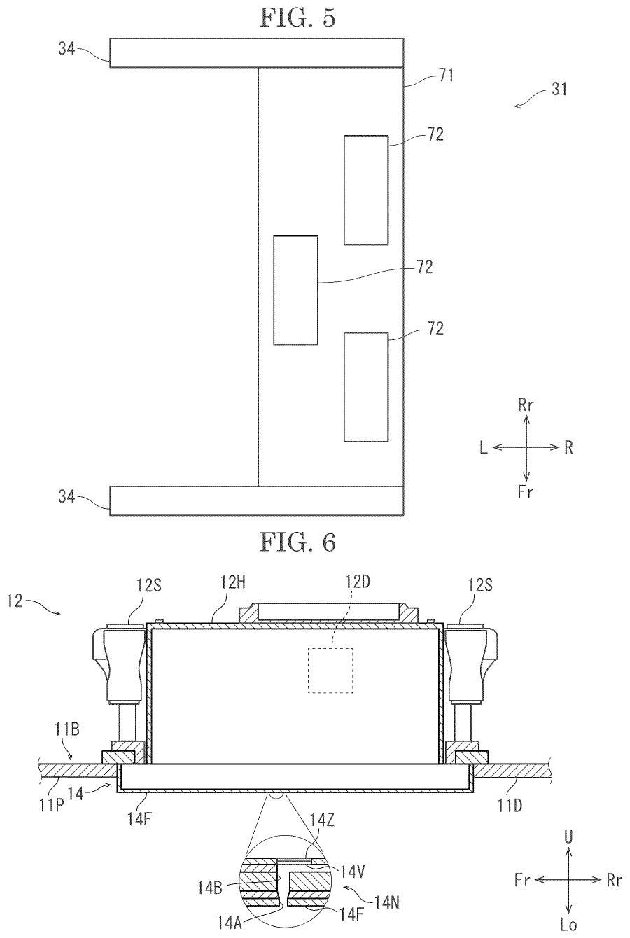

FIG. 1 is a perspective view showing an appearance of an image forming system 100. FIG. 2 is a front view schematically showing an internal configuration of an inkjet recording apparatus 1. FIG. 3 is a front view schematically showing a head unit 11 and a maintenance device 30. FIG. 4 is a plan view schematically showing the head unit 11 and a wipe unit 32. FIG. 5 is a plan view schematically showing a cap unit 31. FIG. 6 is a cross-sectional view showing an inkjet head 12. Hereinafter, the front side of the paper plane on which FIG. 2 is drawn is defined as the front side of the inkjet recording apparatus 1, and the left-and-right direction will be described with reference to the direction in which the inkjet recording apparatus 1 is viewed from the front side. U, Lo, L, R, Fr and Rr in each drawing indicate the upper, lower, left, right, front and rear, respectively.

The image forming system 100 (see FIG. 1) includes a sheet feeding device 110, an inkjet recording apparatus 1, a drying device 120, and a post-processing device 130. The sheet feeding device 110 stores several thousand sheets, and feeds the sheets to the inkjet recording apparatus 1. The inkjet recording apparatus 1 forms an image on the sheet by an inkjet method. The drying device 120 heats the sheet conveyed from the inkjet recording apparatus 1 to dry the ink. The post-processing device 130 performs post-processing such as punching, stapling, folding, or the like on the sheet S conveyed from the drying device 120.

The inkjet recording apparatus 1 (see FIG. 2) includes a rectangular parallelepiped body housing 3. In the center portion inside the body housing 3, a conveying unit 7 which attracts and conveys the sheet in the Y direction is provided. Above the conveying unit 7, an image forming unit 6 which forms an image by ejecting the ink is provided. On the right side surface of the body housing 3, a sheet feeding port 8 through which the sheet is introduced from the sheet feeding device 110 is provided. On the left side surface of the body housing 3, a discharge port 9 through which the sheet on which the image is formed is discharged to the drying device 120 is provided. Inside the body housing 3, a conveyance path 10 is provided from the sheet feeding port 8 to the discharge port 9 through a space between the conveying unit 7 and the image forming unit 6. A registration roller 18 is provided on the upstream side of the conveying unit 7 in the conveyance direction Y.

The conveying unit 7 includes an endless conveying belt 21 and a suction part 24. The conveying belt 21 has a large number of air holes (not shown), and is wound around a driving roller 25 and a driven roller 22. The upper surface of the suction part 24 has a large number of air holes (not shown), and is in contact with the inner surface of the conveying belt 21. The suction part 24 sucks air through the air holes of the conveying belt 21 and the air holes of the suction part 24, thereby attracting the sheet S to the conveying belt 21. When the driving roller 25 is driven in the counterclockwise direction by a driving part (not shown) including a motor and a reduction gear, the conveying belt 21 travels in the counterclockwise direction, and the sheet S attracted to the conveying belt 21 is conveyed in the Y direction.

The image forming unit 6 includes a plurality of (in this embodiment, four) head units 11. The head unit 11 (see FIG. 3 and FIG. 4) includes one or more (in this embodiment, three) inkjet heads 12. Ink containers 20 filled with the black, cyan, magenta and yellow inks are connected to the corresponding head units 11.

The inkjet head 12 (see FIG. 6) includes a rectangular parallelepiped housing 12H whose longitudinal direction is along the front-and-rear direction, a nozzle plate 14 provided at the bottom of the housing 12H, and a socket 12S to which a pipe for supplying the ink is connected. The nozzle plate 14 is provided with a large number of nozzles 14N arranged in the front-and-rear direction. The nozzle 14N includes a branch flow pass 14B branched from the downstream side of the socket 12S, and an ejection port 14A provided on a nozzle surface 14F which is the lower surface of the nozzle plate 14. A diaphragm 14V serves as a part of the inner wall of the branch flow pass 14B. The diaphragm 14V is provided with a pressurizing element 14Z. As the pressurizing element 14Z, a piezoelectric element, an electrostatic actuator, a heater or the like are used. A driving circuit 12D for driving the pressurizing element 14Z is connected to the pressurizing element 14Z.

A control part 2 (see FIG. 2) includes an arithmetic part and a storage part (not shown). The arithmetic part is, for example, a CPU (Central Processing Unit). The storage part includes a storage medium such as a ROM (Read Only Memory), a RAM (Random Access Memory), an EEPROM (Electrically Erasable Programmable Read Only Memory), and the like. The arithmetic part reads out the control program stored in the storage part and executes various processes. The control part 2 may be implemented by an integrated circuit that does not use software.

A display operation part 19 is provided on the upper portion of the body housing 3 (see FIG. 1 and FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with an operation detected by the touch panel and the keypad.

The basic image forming operation of the inkjet recording apparatus 1 is as follows. When an image forming job is inputted to the inkjet recording apparatus 1 from the display operation part 19 or an external computer, the sheet feeding device 110 feeds the sheet S to the conveyance path 10 through the sheet feeding port 8, and the registration roller 18 whose rotation is stopped corrects the skew of the sheet S. When the registration roller 18 sends the sheet S to the conveying unit 7 at a predetermined timing, the conveying unit 7 attracts the sheet S to the conveying belt 21 and conveys the sheet S in the Y direction. The ink is ejected from the inkjet heads 12 to form an image on the sheet S. The sheet S on which the image is formed is discharged to the drying device 120 through the discharge port 9.

[Maintenance Device] Next, a maintenance device 30 will be described. Since the four head units 11 (see FIG. 2) have the same configuration and the four maintenance devices 30 have the same configuration, one head unit 11 and one maintenance device 30 which maintains the head unit 11 will be described below.

[Head Base] The head unit 11 includes a head base 11B (see FIG. 3, FIG. 4 and FIG. 6) which supports the inkjet heads 12. The head base 11B supports the three inkjet heads 12 arranged in a staggered pattern. The head base 11B is a generally rectangular plate-like member whose longitudinal direction is along the front-and-rear direction. The head base 11B has through holes (not shown) into which the nozzle plates 14 of the inkjet heads 12 are inserted. The lower surface of the head base 11B is a surface parallel to the nozzle surface 14F (hereinafter, it is referred to as a parallel plane 11P). The nozzle surface 14F protrudes downward from the parallel surface 11P.

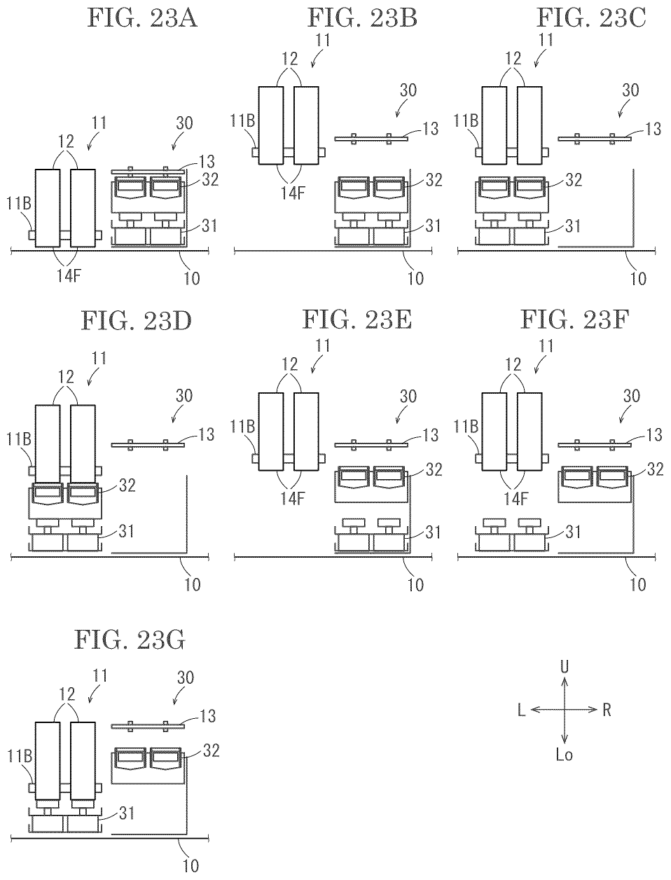

The maintenance device 30 (see FIG. 3) is provided on a lateral side (in this embodiment, the upstream side in the conveyance direction Y (the right side)) of the head unit 11. The maintenance device 30 includes a cap unit 31, a wipe unit 32, and a cleaning liquid supply source 13.

[Cap Unit] The cap unit 31 (see FIG. 3 and FIG. 5) includes the same number (in this embodiment, three) of caps 72 as the inkjet heads 12 provided in the head unit 11. The three caps 72 are arranged in the same staggered pattern as the inkjet heads 12, and are supported by a frame body 71.

[Wipe Unit] The wipe unit 32 (see FIG. 3 and FIG. 4) includes a waste liquid tray 81, a blade 82, and a cleaning liquid supply part 40. The waste liquid tray 81 includes the same number of recesses 81U as the inkjet heads 12 provided in the head unit 11. The recesses 81U are arranged in the same staggered pattern as the inkjet heads 12. The blade 82 and the cleaning liquid supply part 40 are provided in each of the recesses 81U.

[Head Lifting Device] FIG. 23 is a front view explaining an operation of the maintenance device 30. Head lifting devices 11L (see FIG. 4) are provided on the front and rear sides of the head base 11B, respectively. The head lifting device 11L includes, for example, a ball screw, a belt driving device, and the like. The head lifting devices 11L lift and lower the head unit 11 between an image forming position (see FIG. 23A) and a retracted position (see FIG. 23B). The image forming position is a position where a distance between the conveyance path 10 (the upper surface of the conveying belt 21) on which the sheet S is conveyed and the nozzle surface 14F is a predetermined distance suitable for the image forming. The retracted position is a position above the image forming position and where the head unit 11 does not interfere with the wipe unit 32 when the cap unit 31 and the wipe unit 32 are slid using a cap sliding device 34 described later.

[Cap Sliding Device] The cap sliding devices 34 (see FIG. 5) are provided on the front and rear sides of the frame body 71 of the cap unit 31, respectively. The cap sliding device 34 includes, for example, a ball screw, a belt driving device, and the like. The cap sliding devices 34 slide the cap unit 31 to a home position (see FIG. 23A) and a maintenance position (see FIG. 23F). The home position is a position on the right side of the head unit 11 positioned at the image forming position. The maintenance position is a position below the head unit 11 positioned at the retracted position.

[Wipe Lifting Device] Wipe lifting devices 35 (see FIG. 4) are provided on the front and rear sides of the waste liquid tray 81 of the wipe unit 32, respectively. The wipe lifting device 35 includes, for example, a cam mechanism, a ball screw, and the like. The wipe lifting devices 35 lift and lower the wipe unit 32 to a contact position (see FIG. 23B) and a separated position (see FIG. 23E). The contact position is a position where the waste liquid tray 81 comes into contact with the caps 72. The separated position is a position where the waste liquid tray 81 is separated upward from the caps 72 by a predetermined distance.

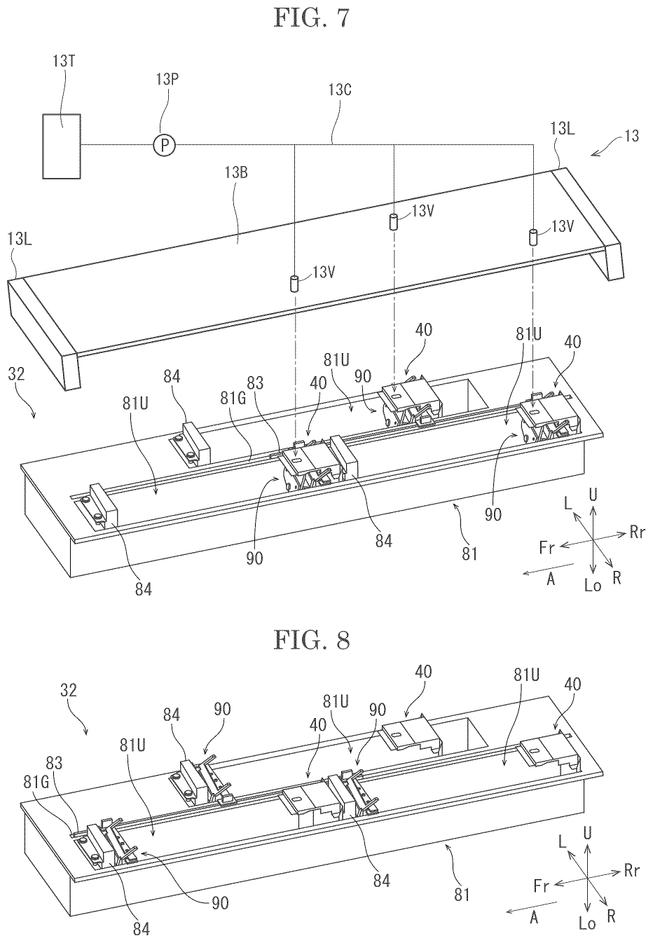

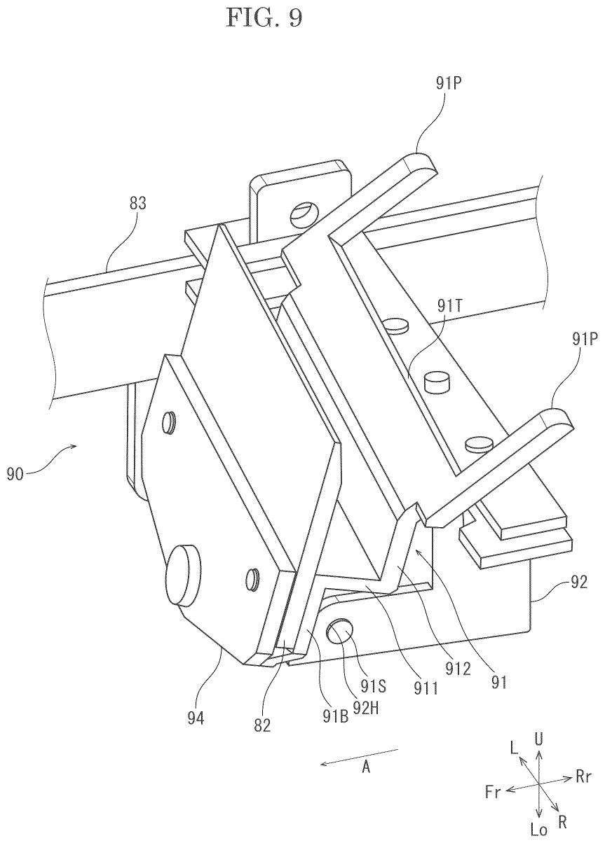

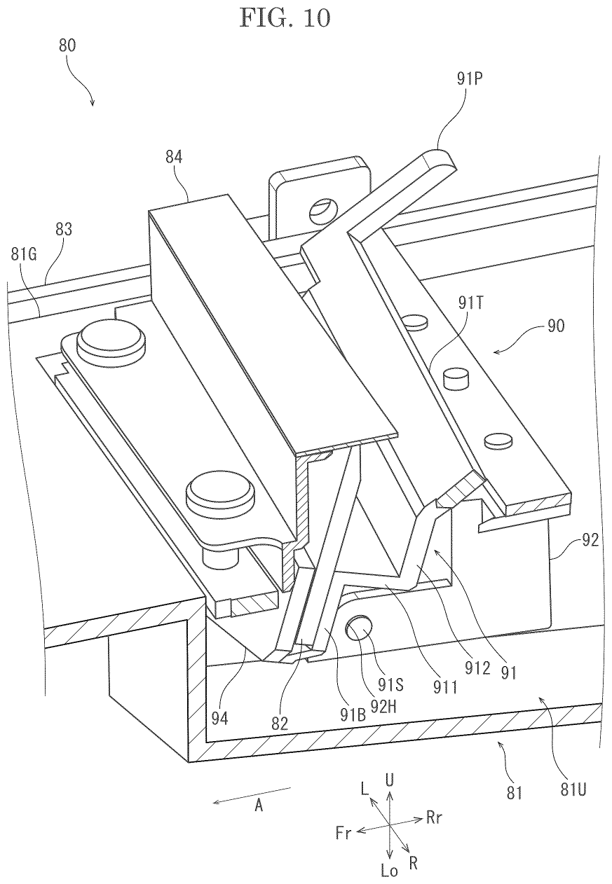

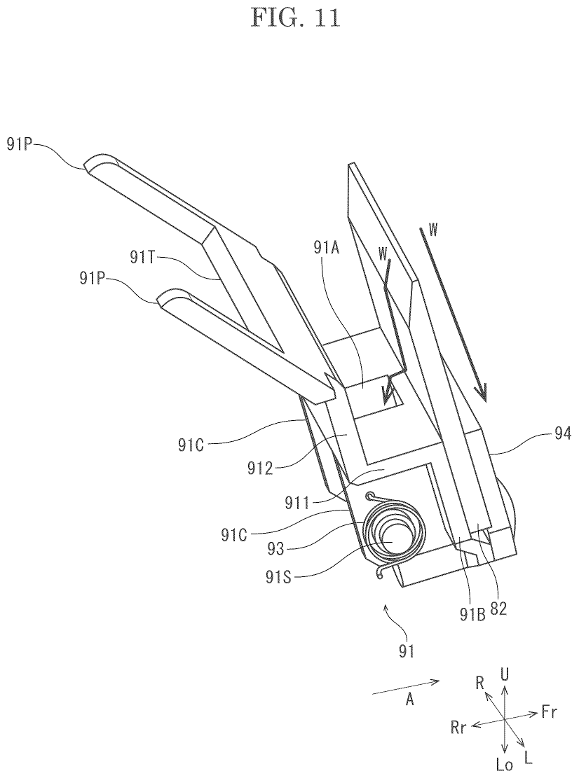

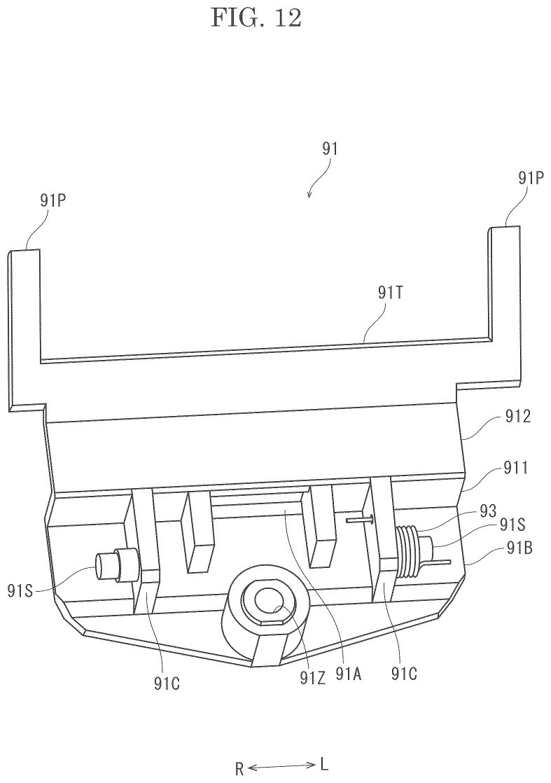

When the wipe unit 32 is positioned at the contact position, since the wipe unit 32 is placed on the cap unit 31, the wipe unit 32 slides to the home position and the maintenance position together with the cap unit 31 by operating the cap sliding device 34. That is, the cap sliding device 34 also functions as a wipe slide device for sliding the wipe unit 32 to the home position and the maintenance position. When the wipe unit 32 is positioned at the separated position, the cap unit 31 slides independently to the home position and the maintenance position while leaving the wipe unit 32 at the home position by operating the cap sliding device 34.

[Wipe Unit] Next, the configuration of the wipe unit 32 will be described in detail. FIG. 7 is a perspective view showing the wipe unit 32 and the cleaning liquid supply source 13. FIG. 8 is a perspective view showing the wipe unit 32. FIG. 9 is a perspective view showing a blade unit 90. FIG. 10 is a perspective view showing a cross section of the blade unit 90. FIG. 11 is a perspective view showing a protruding member 91 and a blade 82. FIG. 12 is a perspective view showing the protruding member 91.

The wipe unit 32 includes a plurality (in this embodiment, three) of blade units 90, a waste liquid tray 81, and a carriage 83. The blade unit 90 (see FIG. 11 and FIG. 12) includes a blade 82, a protruding member 91, a holder 92, and a first biasing member 93.

[Blade] The blade 82 (see FIG. 9 to FIG. 11) is a flexible, generally rectangular plate-like member made of resin or the like. The blade 82 is held by the holder 92 in a slightly rearward inclined posture with its thickness direction along the front-and-rear direction. A width of the blade 82 in the left-and-right direction is equal to or larger than a width of the nozzle surface 14F. The upper portion of the blade 82 is tapered such that the thickness becomes thinner toward the tip end.

[Protruding Member] The protruding member 91 (see FIG. 9 to FIG. 12) is integrated with the blade 82. The protruding member 91 has a base portion 91B parallel to the blade 82, a first bent portion 911 bent rearward from the upper end portion of the base portion 91B, a second bent portion 912 bent upward from the rear end portion of the first bent portion 911, a rearward inclined portion 91T inclined rearward more than the second bent portion 912, and protruding portions 91P protruding upward from both the left and right end portions of the rearward inclined portion 91T and inclined rearward at the same inclination angle as the inclination angle of the rearward inclined portion 91T.

A width of the base portion 91B in the left-and-right direction is equal to a width of the blade 82. A length of the base portion 91B in the upper-and-lower direction is shorter than a length of the blade 82 in the upper-and-lower direction. The base portion 91B is joined to the lower portion of the rear surface of the blade 82. Widths of the first bent portion 911 and the second bent portion 912 in the left-and-right direction are equal to a width of the base portion 91B. A width of the rear inclined portion 91T in the left-and-right direction is wider than a width of the base portion 91B. Positions of the protruding portions 91P in the left-and-right direction are set such that the tip ends of the protruding portions 91P are capable of coming into contact with the parallel surface 11P on the left and right sides of the nozzle surface 14F.

On the rear surface of the base portion 91B, two wall portions 91C facing each other in the left-and-right direction are provided (see FIG. 11 and FIG. 12). A shaft portion 91S protruding leftward is provided on the left surface of the left wall portion 91C. A shaft portion 91S protruding rightward is provided on the right surface of the right wall portion 91C.

A through-hole 91A penetrating downward is formed in the center portion of the first bent portion 911 in the left-and-right direction (see FIG. 11 and FIG. 12). At least a part of a waste liquid W (a mixture of the ink and a cleaning liquid) flowing down along the rear surface of the blade 82 falls downward through the through-hole 91A.

[Fixing Member]A fixing member 94 (see FIG. 9 to FIG. 11) fixes the blade 82 to the protruding member 91. The lower portion of the blade 82 is held between the base portion 91B of the protruding member 91 and the fixing member 94, and the fixing member 94 is fastened to the protruding member 91. The lower edge portion of the fixing member 94 and the lower edge portion of the protruding member 91 each has a taper portion (see FIG. 9 and FIG. 12) whose width in the left-and-right direction becomes narrower toward the lower side. The waste liquid flowing down from the front surface of the blade 82 to the front surface of the fixing member 94 collects at the center in the left-and-right direction along the lower edge of the fixing member 94 and the lower edge of the protruding member 91, and falls into the recess 81U of the waste liquid tray 81.

[Holder] The holder 92 (see FIG. 9 to FIG. 11) holds the blade 82 through the protruding member 91. Shaft holes 92H into which the shaft portions 91S of the protruding member 91 are inserted are provided in the lower portion of the holder 92. The protruding member 91 can swing in the front-and-rear direction around the shaft portions 91S. The blade 82 swings together with the protruding member 91. The blade 82 and the protruding member 91 are provided in the holder 92 in a posture inclined with respect to the left-and-right direction such that the waste liquid W flows in one of the left and right directions. In the illustrated example, the left end of the blade 82 is inclined slightly rearward of the right end, but may be inclined in the opposite direction.

[First Biasing Member] The first biasing member 93 (see FIG. 11 and FIG. 12) is, for example, a torsion coil spring, and is wound around the shaft portion 91S. One end of the first biasing member 93 is engaged with the holder 92, and the other end is engaged with the protruding member 91. The first biasing member 93 biases the protruding member 91 in the counterclockwise direction in FIG. 9 and FIG. 10 and in the clockwise direction in FIG. 11. In other words, the first biasing member 93 biases the blade 82 in a direction in which the tip of the blade 82 is pressed against the nozzle surface 14F. The first biasing member 93 may be a plate spring, a compression coil spring, or the like.

[Waste Liquid Tray] The waste liquid tray 81 (see FIG. 7 and FIG. 8) is formed in a rectangular shape whose longitudinal direction is along the front-and-rear direction as a whole. The waste liquid tray 81 has three recesses 81U whose upper sides are opened. The three recesses 81U are arranged in the same staggered pattern as the inkjet heads 12. The recess 81U is formed in a rectangular shape elongated in the front-and-rear direction when viewed from the upper side. A length of the recess 81U in the front-and-rear direction is longer than that of the nozzle surface 14F, and a width of the recess 81U in the left-and-right direction is wider than that of the nozzle surface 14F. The recess 81U receives the waste liquid containing the ink and the cleaning liquid.

[Carriage] The carriage 83 (see FIG. 7 to FIG. 10) is formed in a plate shape whose longitudinal direction is along the front-and-rear direction. A groove 81G extending in the front-and-rear direction is provided between the left and right recesses 81U, and the carriage 83 is accommodated in the groove 81G. A length of the carriage 83 in the front-and-rear direction is shorter than a length of the groove 81G in the front-and-rear direction. The carriage 83 is slidable in the front-and-rear direction along the groove 81G.

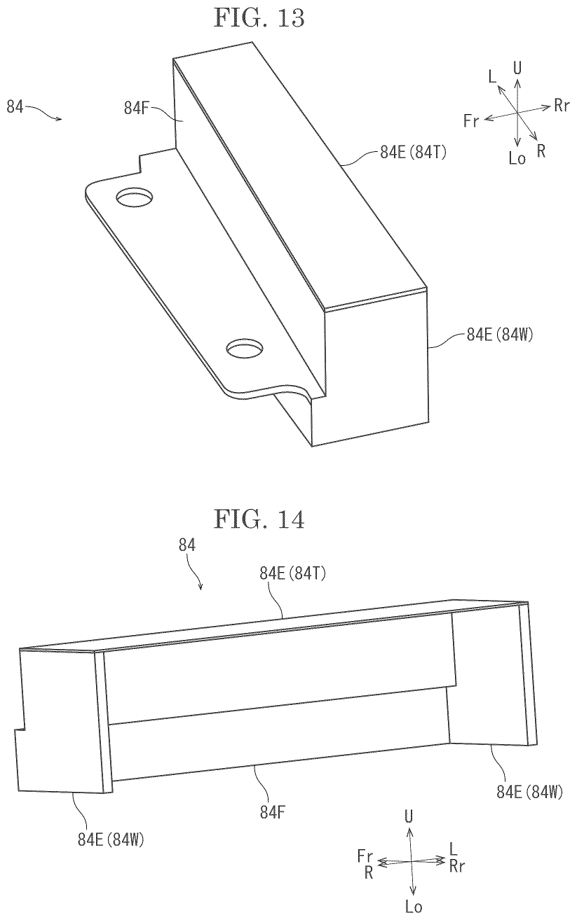

The blade unit 90 is housed in each of the three recesses 81U. The three blade units 90 are coupled to the carriage 83. The three blade units 90 are arranged on the carriage 83 such that the three blade units 90 are positioned rearward of the nozzle surface 14F when the carriage 83 is positioned rearmost.

[Carriage Driving Device] The waste liquid tray 81 is provided with a carriage driving device 36 (see FIG. 4). The carriage driving device 36 includes, for example, a belt driving device, a feed screw, and the like, and slides the blades 82 by sliding the carriage 83 along the groove 81G. By sliding the blade 82 forward (one example of the moving direction A in the wiping operation), the wiping operation in which the blade 82 scrapes the ink from the nozzle surface 14F is performed. FIG. 7 shows a state in which the blade 82 is positioned at a wiping operation start position. FIG. 8 shows a state in which the blade 82 is positioned at a wiping operation end position.

[Receiving Member] FIG. 13 and FIG. 14 are perspective views showing the receiving member 84. The receiving member 84 is supported by the waste liquid tray 81 (see FIG. 7, FIG. 8 and FIG. 10). The receiving member 84 is provided at the front end of each of the three recesses 81U. The receiving member 84 has a front surface portion 84F facing the front surface of the blade 82, a ceiling portion 84T provided rearward from the upper end of the front surface portion 84F, and side walls 84W provided rearward from both right and left ends of the front surface portion 84F. That is, the receiving member 84 is formed in a box shape whose rear side and lower side are opened.

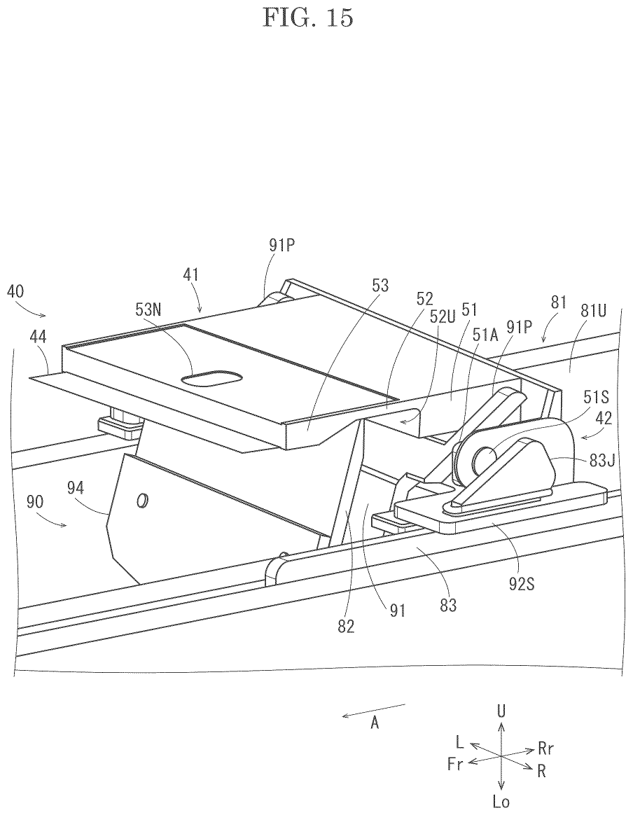

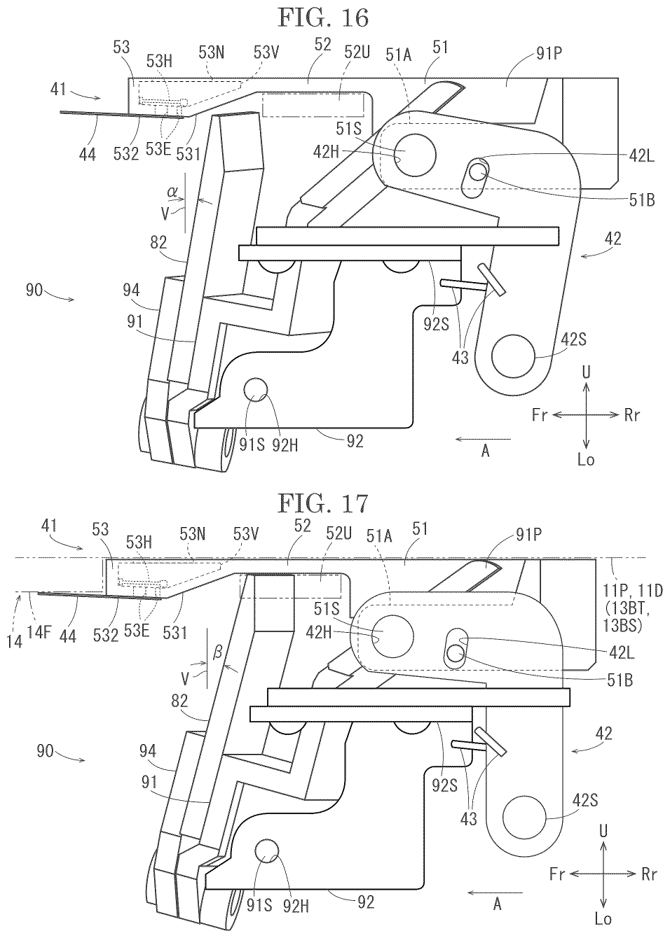

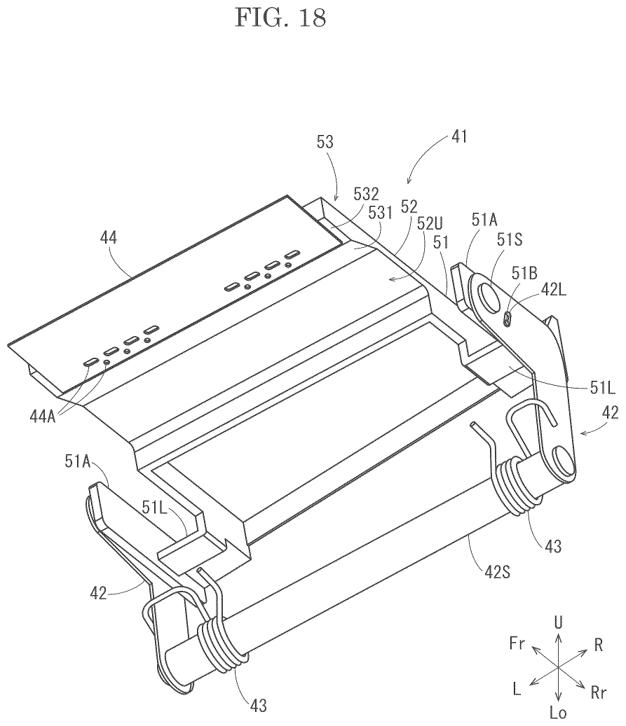

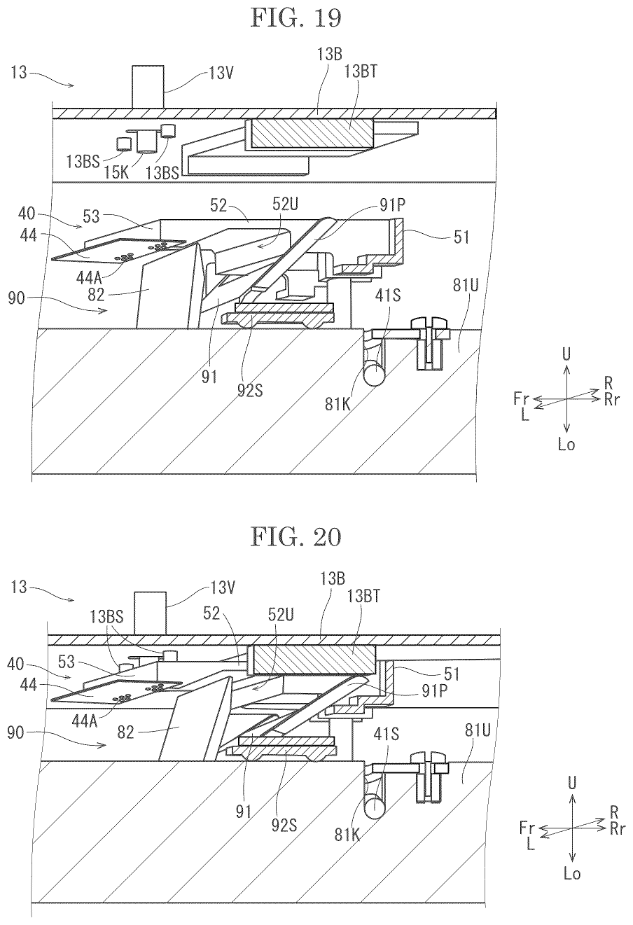

When the blade 82 reaches the foremost portion of the recess 81U, the blade 82 is stored in the receiving member 84. At this time, the blade 82 is surrounded by the receiving member 84 from the front side, the upper side, and the right and left sides. Either the ceiling portion 84T or the side wall portions 84W may be provided.

[Cleaning Liquid Supply Part] Next, the cleaning liquid supply part 40 will be described. FIG. 15 is a perspective view showing the cleaning liquid supply part 40 and the blade unit 90. FIG. 16 and FIG. 17 are right side views showing the cleaning liquid supply part 40 and the blade unit 90. FIG. 18 is a perspective view showing the cleaning liquid supply part 40. FIG. 19 to FIG. 22 are perspective views showing cross sections of the cleaning liquid supply part 40 and the cleaning liquid supply source 13. The cleaning liquid supply part 40 includes a supply member 41, a link member 42, and a delivery member 44.

[Supply Member] The supply member 41 has a base end portion 51, an intermediate portion 52, and a storage portion 53 in this order from the rear side. The upper surface of the supply member 41 is flat and rectangular when viewed from the upper side. A portion of the parallel surface 11P of the head base 11B on the rear side of the nozzle plate 14 faces the upper surface of the supply member 41, and also serves as a pushing portion 11D for pushing down the supply member 41. The pushing portion 11D may be provided as a member separate from the head base 11B.

Arm support portions 51L protruding leftward and rightward are provided on the left and right side surfaces of the base end portion 51, respectively (see FIG. 18). The left and right arm support portions 51L are respectively provided with arm portions 51A protruding forward (see FIG. 16 to FIG. 18). A shaft portion 51S protrudes from the left side surface of the left arm portion 51A, and a shaft portion 51S protrudes from the right side surface of the right arm portion 51A. Bosses 51B are provided on the rear sides of the right and left shaft portions 51S.

The intermediate portion 52 is thinner in the upper-and-lower direction than the base end portion 51 (see FIG. 16 to FIG. 18). The lower surface of the intermediate portion 52 is flat. The lower surface of the storage portion 53 has a first inclined surface 531 and a second inclined surface 532 provided in front of the first inclined surface 531. The first inclined surface 531 is inclined such that the front side is lower than the rear side (see FIG. 16 and FIG. 17). The second inclined surface 532 is inclined such that the front side is higher than the rear side. The first inclined surface 531 is continuous with the lower surface of the intermediate portion 52. Therefore, a larger space (hereinafter, it is referred to as a non-contact space 52U) is formed below the intermediate portion 52 than below the storage portion 53.

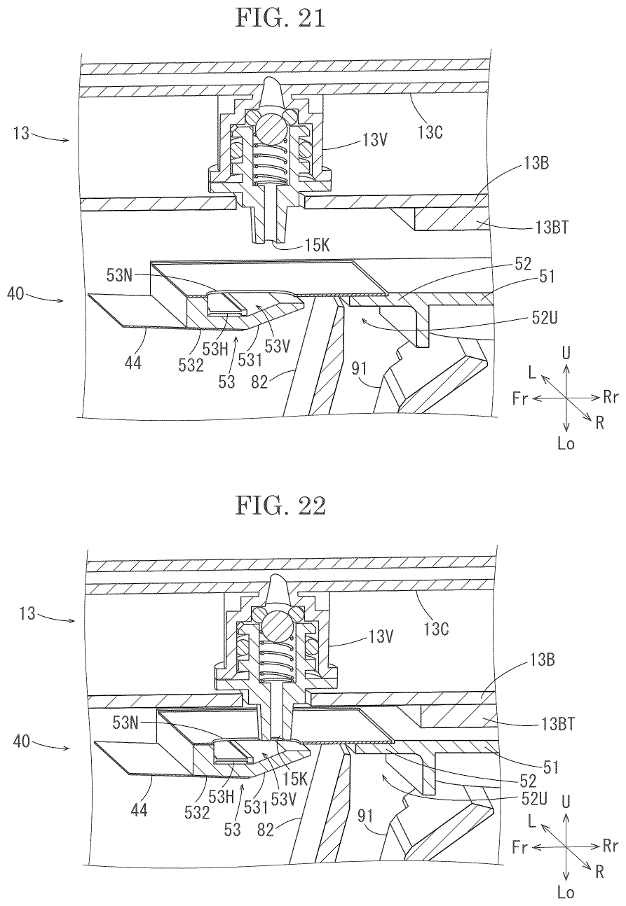

The storage portion 53 has a hollow structure having a storage space 53V for storing the cleaning liquid (see FIG. 16 and FIG. 17). Preferably, a cleaning liquid holding member 53H (see FIG. 21 and FIG. 22) for holding the cleaning liquid, such as a net-like member or a porous member, is provided in the storage space 53V. An intake port 53N (see FIG. 15, FIG. 21 and FIG. 22) through which the cleaning liquid is taken in is provided on the upper surface of the storage portion 53. A discharge port 53E (see FIG. 16 and FIG. 17) through which the cleaning liquid is discharged is provided on the lower surface of the storage portion 53. A thickness of the front end portion of the storage portion 53 in the upper-and-lower direction (a distance from the front end portion of the second inclined surface 532 to the upper surface) is slightly larger than a distance from the lower surface of the head base 11B to the nozzle surface 14F.

[Link Member] The link members 42 are provided on the left and right sides of the supply member 41 (FIG. 15 to FIG. 18). The lower portions of the right and left link members 42 are connected by a shaft 42S (see FIG. 18) whose longitudinal direction is along the left-and-right direction. The shaft 42S is rotatably supported by the recess 81U of the waste liquid tray 81. Specifically, the waste liquid tray 81 has notches 81K formed downward from the upper ends of the right and left side walls of the recess 81U (see FIG. 19 and FIG. 20). Both the right and left ends of the shaft 42S are supported by the notches 81K. The link member 42 is swingable around the shaft 42S.

Shaft holes 42H into which the shaft portions 51S of the supply member 41 are inserted are provided in the upper portions of the right and left link members 42 (see FIG. 16 to FIG. 18). The shaft hole 42H is disposed in front of the shaft 42S. An elongated hole 42L into which the boss 51B of the supply member 41 is inserted is provided on the rear side of the shaft hole 42H. The supply member 41 is swingable with respect to the link members 42 around the shaft portions 51S within a range in the longitudinal direction of the elongated hole 42L (see FIG. 16 and FIG. 17).

[Second Biasing Member] The link member 42 is provided with a second biasing member 43 (see FIG. 18). Specifically, the second biasing member 43 is a torsion coil spring, and is wound around the shaft 42S. One end of the second biasing member 43 is engaged with the holder 92, and the other end is engaged with the link member 42 (see FIG. 16 and FIG. 17). The second biasing member 43 biases the link member 42 in the clockwise direction in FIG. 16 and FIG. 17. In other words, the second biasing member 43 biases the supply member 41 in a direction close to the inkjet head 12. The second biasing member 43 may be a plate spring, a compression coil spring, or the like.

[Delivery Member] The delivery member 44 is joined to the second inclined surface 532. The delivery member 44 has the same inclination angle as the second inclined surface 532. The delivery member 44 is a rectangular sheet-like member made of resin or the like, and has flexibility. The front end portion of the delivery member 44 protrudes forward from the front end portion of the storage portion 53. The delivery member 44 is provided with a discharge port 44A at a position corresponding to the discharge port 53E of the storage portion 53 (see FIG. 18).

[Overview of Cleaning Liquid Source] The cleaning liquid supply source 13 (see FIG. 7, FIG. 19 to FIG. 22) supplies the cleaning liquid to the supply member 41. The cleaning liquid is a liquid containing water as a main component. The cleaning liquid supply source 13 includes a tank 13T, a pump 13P, a supply flow pass 13C, and a support plate 13B. The cleaning liquid is stored in the tank 13T. The supply flow pass 13C is branched into three passes on the downstream side of the pump 13P. Each of the branched supply flow passes 13C is connected to a check valve 13V. The three check valves 13V are disposed above the intake ports 53N of the supply member 41. The supply flow passes 13C and the check valves 13V are supported by the support plate 13B. The check valve 13V passes through the support plate 13B, and the discharge port 15K of the check valve 13V protrudes from the lower surface of the support plate 13B.

Supply source lifting devices 13L (see FIG. 7) are provided on the front and rear sides of the support plate 13B. The supply source lifting device 13L includes, for example, a cam mechanism and a ball screw. The supply source lifting devices 13L lift and lower the support plate 13B to a supply position (see FIG. 23A) and a retracted position (see FIG. 23B). The supply position is a position where the discharge ports 15K of the check valves 13V are inserted into the intake ports 53N (see FIG. 20 and FIG. 22). The retracted position is a position where the discharge ports 15K of the check valves 13V retract upward from the intake ports 53N (see FIG. 19 and FIG. 21).

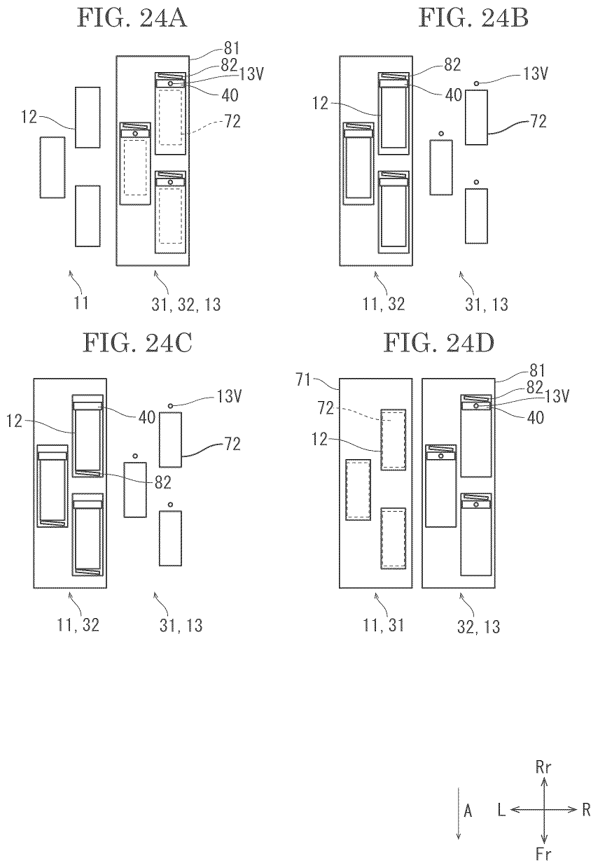

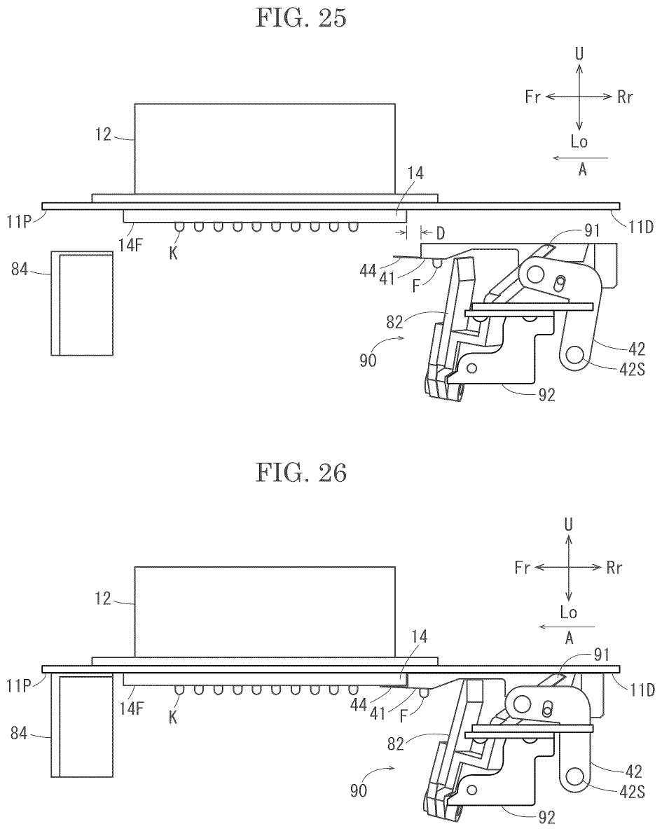

On the lower surface of the support plate 13B, convex portions 13BT protruding downward are provided at positions corresponding to the protruding portions 91P of the protruding member 91 (see FIG. 19 to FIG. 22). On the lower surface of the support plate 13B, convex portions 13BS protruding downward are provided on the left and right sides of the check valve 13V (see FIG. 19 and FIG. 20).

[Overview of Operation of Wipe Unit] Next, an overview of the operation of the wipe unit 32 will be described. FIG. 24 is a plan view explaining the operation of the wipe unit 32. FIG. 25 to FIG. 30 are right side views explaining the operation of the wipe unit 32. Here, the overview of the operation of the wipe unit 32 will be described, and the operations of the protruding member 91 and the supply member 41 will be described later.

Hereinafter, the state shown in FIG. 23A and FIG. 24A will be described as the initial state. In the initial state, the head unit 11 is positioned at the image forming position (see FIG. 23A), the cap unit 31 is positioned at the home position, the wipe unit 32 is positioned at the home position and the contact position, and the cleaning liquid supply source 13 is positioned at the supply position. The blade 82 is positioned at the wiping operation start position (see FIG. 24A). A predetermined amount of the cleaning liquid is supplied from the cleaning liquid supply source 13 to the cleaning liquid supply part 40. The control part 2 executes the following processing at a predetermined timing. The predetermined timing is, for example, a timing in which a viscosity of the ink in the nozzle 14N is expected to increase, and more specifically, a case in which a period in which the image forming job is not executed continues for a predetermined period.

First, the control part 2 operates the head lifting devices 11L to lift the head unit 11 to the retracted position (see FIG. 23B). Further, the control part 2 operates the supply source lifting devices 13L to lift the cleaning liquid supply source 13 to the retracted position.

Next, the control part 2 operates the cap sliding devices 34 to slide the cap unit 31 to the maintenance position (see FIG. 23C, FIG. 24B and FIG. 25). At this time, since the wipe unit 32 is placed on the cap unit 31, the wipe unit 32 slides to the maintenance position together with the cap unit 31. Next, the control part 2 operates the head lifting devices 11L to lower the head unit 11 to a height (hereinafter, it is referred to as a wipe position) at which the wiping operation is performed (see FIG. 23D and FIG. 26).

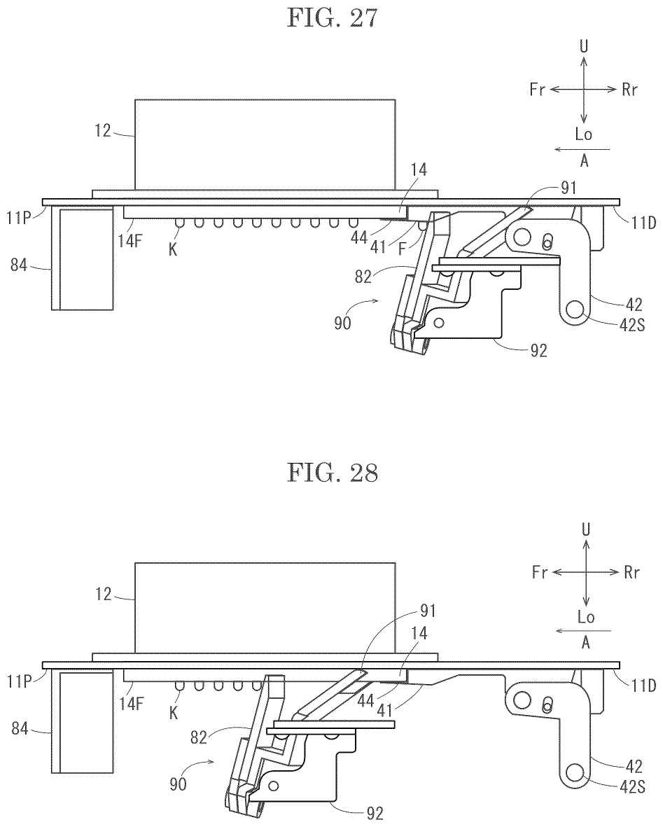

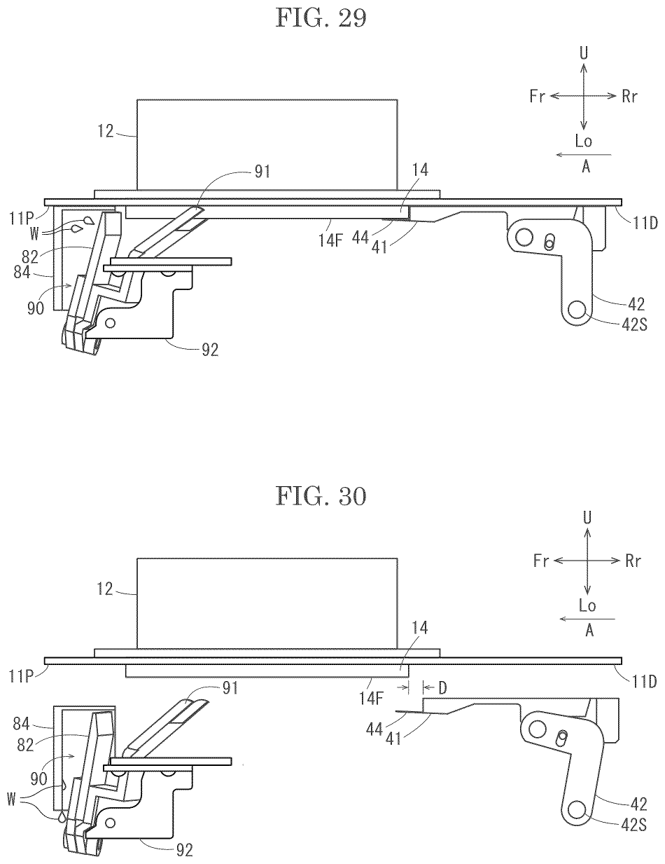

Next, after ejecting a predetermined amount of the ink from the inkjet head 12, the control part 2 operates the carriage driving device 36 to slide the blade 82 forward along the nozzle surface 14F (see FIG. 24C, FIG. 27, FIG. 28 and FIG. 29). The blade 82 scrapes the cleaning liquid F swollen from the discharge port 44A (see FIG. 27), and moves forward along the nozzle surface 14F (see FIG. 28 and FIG. 29). On the nozzle surface 14F, the remaining ink K is diluted by the cleaning liquid F carried by the blade 82. The waste liquid containing the remaining ink K and the cleaning liquid F is scraped off by the blade 82, and falls into the recess 81U.

Next, the control part 2 operates the head lifting devices 11L to lift the head unit 11 to the retracted position (see FIG. 23C and FIG. 30). Next, the control part 2 operates the carriage driving device 36 to return the blade 82 to the wiping operation start position (see FIG. 24B and FIG. 25). Next, the control part 2 operates the cap sliding devices 34 to slide the cap unit 31 and the wipe unit 32 to the home position (see FIG. 23B and FIG. 24A).

Next, the control part 2 operates the wipe lifting devices 35 to lift the wipe unit 32 to the separated position (see FIG. 23E). Next, the control part 2 operates the cap sliding devices 34 to slide the cap unit 31 to the maintenance position (see FIG. 23F and FIG. 24D). At this time, since the wipe unit 32 is separated from the cap unit 31, the wipe unit 32 remains at the home position and only the cap unit 31 slides to the maintenance position.

Next, the control part 2 operates the head lifting devices 11L to lower the head unit 11 to a height (hereinafter, it is referred to as a cap position) at which the nozzle surface 14F is in contact with the caps 72 (see FIG. 23G). Thus, the caps 72 are attached to the nozzle surface 14F.

When the image forming job is executed, the control part 2 operates the head lifting devices 11L to lift the head unit 11 to the retracted position (see FIG. 23F), operates the cap sliding devices 34 to slide the cap unit 31 to the home position (see FIG. 23E), and operates the wipe lifting devices 35 to lower the wipe unit 32 to the contact position (see FIG. 23B). Then, the control part 2 operates the head lifting devices 11L to lower the head unit 11 to the image forming position (see FIG. 23A), and then executes the image forming job.

[Operation of Protruding Member and Supply Member] Next, the operation of the protruding member 91 and the supply member 41 will be described. FIG. 16 shows a state in which the protruding member 91 and the supply member 41 are not pushed down (hereinafter, it is referred to as a non-pushed down state). On the other hand, FIG. 17 shows a state (hereinafter, it is referred to as a pushed down state) in which the protruding member 91 is pushed down by the parallel surface 11P or the convex portion 13BT, and the supply member 41 is pushed down by the pushing portion 11D or the convex portion 13BS. The first biasing member 93 biases the protruding member 91 in the counterclockwise direction in FIG. 16 and FIG. 17. The second biasing member 43 biases the link member 42 in the clockwise direction.

[Non-pushed Down State] When the wipe unit 32 is positioned at the home position and the cleaning liquid supply source 13 is lifted to the retracted position, it is the non-pushed down state (see FIG. 19, FIG. 21, FIG. 23B, FIG. 23E, FIG. 23F and FIG. 23G). Also, when the wipe unit 32 is positioned at the maintenance position and the head unit 11 is lifted to the retracted position, it is the non-pushed down state (see FIG. 23C).

[Pushed Down State] On the other hand, when the wipe unit 32 is positioned at the home position and the cleaning liquid supply source 13 is lowered to the supply position, it is the pushed down state (see FIG. 20, FIG. 22 and FIG. 23). Specifically, when the cleaning liquid supply source 13 is lowered (see FIG. 17, FIG. 20 and FIG. 22) from the non-pushed down state (see FIG. 16, FIG. 19 and FIG. 21), the convex portions 13BT push down the protruding portions 91P against the first biasing member 93, and the convex portions 13BS pushes down the supply member 41 against the second biasing member 43. At this time, the discharge ports 15K of the check valves 13V are inserted into the intake ports 53N of the supply member 41 (see FIG. 22), and the cleaning liquid can be supplied from the cleaning liquid supply source 13 to the cleaning liquid supply part 40.

Also, when the wipe unit 32 is positioned at the maintenance position and the head unit 11 is lowered to the wipe position, it is the pushed down state (see FIG. 23D). When the head unit 11 is lowered (see FIG. 17) from the non-pushed down state (see FIG. 16), the parallel surface 11P pushes down the protruding portions 91P against the first biasing member 93, and the pushing portion 11D pushes down the supply member 41 against the second biasing member 43.

When it is transited from the non-pushed down state to the pushed down state, the protruding portions 91p are pushed down and the blade 82 swings in the clockwise direction. Therefore, an inclination angle R of the front surface of the blade 82 with respect to the vertical line V in the pushed down state (see FIG. 17) is larger than an inclination angle α in the non-pushed down state (see FIG. 16). When the supply member 41 is pushed down, the link member 42 swings in the counterclockwise direction. Therefore, in the pushed down state, the supply member 41 moves forward and downward as compared with the non-pushed down state.

In the non-pushed down state, the tip of the blade 82 is positioned below the first inclined surface 531 of the supply member 41. On the other hand, in the pushed down state, relatively, the tip of the blade 82 moves rearward and downward and the supply member 41 moves forward and downward, but the tip of the blade 82 enters the non-contact space 52U below the intermediate portion 52 of the supply member 41, so that interference between the blade 82 and the supply member 41 is avoided.

[Wiping Operation] Next, the wiping operation will be described in detail. When the head unit 11 is lifted to the retracted position and the wipe unit 32 is slid to the maintenance position (see FIG. 23C, FIG. 24B and FIG. 25), the protruding member 91 and the supply member 41 are in the not-pushed down state (see FIG. 16). At this time, the rear end surface of the nozzle plate 14 and the front end surface of the supply member 41 are spaced apart in the front-and-rear direction by a distance D (see FIG. 25). The cleaning liquid F is swollen from the discharge port 44A (see FIG. 18) of the delivery member 44 (see FIG. 25). The remaining ink K adheres to the nozzle surface 14F (see FIG. 25).

Next, the control part 2 operates the head lifting devices 11L to lower the head unit 11 to the wipe position (see FIG. 23D and FIG. 26). Then, since the parallel surface 11P pushes down the protruding member 91 and the supply member 41, the protruding member 91 and the supply member 41 are in the pushed down state (see FIG. 17). At this time, the blade 82 swings from the inclination angle α to the inclination angle 3. Since the supply member 41 moves forward, the distance between the front end surface of the supply member 41 and the rear end surface of the nozzle plate 14 is decreased. At this time, the front end surface of the supply member 41 may be in contact with the rear end surface of the nozzle plate 14. Further, since the delivery member 44 moves below the nozzle surface 14F and at least the front end portion of the upper surface of the delivery member 44 comes into contact with the nozzle surface 14F, the step between the second inclined surface 532 and the nozzle surface 14F is eliminated.

Next, the control part 2 ejects a predetermined amount of the ink from the inkjet head 12. By this operation, the ink having increased viscosity is discharged from the nozzle 14N. Next, the control part 2 operates the carriage driving device 36 to slide the blade 82 forward along the nozzle surface 14F (see FIG. 24C). The blade 82 scrapes the cleaning liquid F swelling from the discharge port 44A (see FIG. 27), moves along the lower surface of the delivery member 44 to the nozzle surface 14F, and then moves forward along the nozzle surface 14F (see FIG. 28). In FIG. 27 and FIG. 28, the tip end portion of the blade 82 overlaps the supply member 41 and the nozzle plate 14, but actually, the tip end portion of the blade 82 is bent rearward.

When the blade 82 moves forward along the nozzle surface 14F, the blade 82 moves forward with the protruding member 91 in contact with the parallel surface 11P, so that an inclination angle of the blade 82 is kept constant. Therefore, the blade 82 is pressed against the nozzle surface 14F with a constant load. The blade 82 is pressed against the nozzle surface 14F mainly by the elastic force of the first biasing member 93. The elastic force of the first biasing member 93 is adjusted so as to minimize the deflection of the blade 82.

On the nozzle surface 14F, the remaining ink K is diluted by the cleaning liquid F carried by the blade 82. The waste liquid containing the remaining ink K and the cleaning liquid F is scraped off by the blade 82, and flows down along the front and rear surfaces of the blade 82. The waste liquid W flowing down along the rear surface of the blade 82 passes through the through-hole 91A of the protruding member 91 and falls into the recess 81U (see FIG. 11). The waste liquid W flowing down along the front surface of the blade 82 passes through the front surface of the fixing member 94, is collected in the center in the left-and-right direction along the lower edge of the fixing member 94 and the lower edge of the protruding member 91, and falls into the recess 81U.

In parallel with the blade 82 passing through the front end portion of the nozzle surface 14F (see FIG. 29), the control part 2 operates the head lifting devices 11L to lift the head unit 11 to the retracted position (see FIG. 30). At this time, since the head base 11B is also lifted, the protruding member 91 and the supply member 41 return to the non-pushed down state. Further, since the blade 82 is separated from the nozzle surface 14F, the deflection deformation of the blade 82 is eliminated. By this operation, the waste liquid W is discharged from the blade 82 toward the receiving member 84. The waste liquid W received by the receiving member 84 flows down along the inner surface of the receiving member 84 and falls into the recess 81U.

If the configuration (the protruding member 91, the holder 92, the first biasing member 93, and the others) for changing an inclination angle of the blade 82 is not provided, the blade 82 is pressed against the nozzle surface 14F exclusively by the elastic force due to the flexural deformation of the blade 82 itself. Therefore, when the tip end portion of the blade 82 passes through the front end portion of the nozzle surface 14F, the deflection of the blade 82 is rapidly returned, and there is a possibility that the waste liquid W is scattered. On the other hand, in the present embodiment, the deflection of the blade 82 is suppressed to a smaller amount than in the case where the configuration for changing an inclination angle of the blade 82 is not provided. Further, since the recovery of the inclination of the blade 82 is performed in parallel with the elimination of the deflection deformation, the waste liquid W is mainly discharged forward and received by the receiving member 84, thereby suppressing the scattering of the waste liquid W.

[Details of Cleaning Liquid Supply Source] As described above, when the wipe unit 32 is positioned at the home position and the cleaning liquid supply source 13 is lowered to the supply position, it becomes the pushed down state (see FIG. 20, FIG. 22 and FIG. 23 A). At this time, the discharge port 15K of the check valve 13V is inserted into the intake port 53N of the supply member 41 (see FIG. 22), and the cleaning liquid can be supplied from the cleaning liquid supply source 13 to the cleaning liquid supply part 40. Here, the configuration of the cleaning liquid supply source 13 (an example of the liquid supply apparatus) will be described in detail.

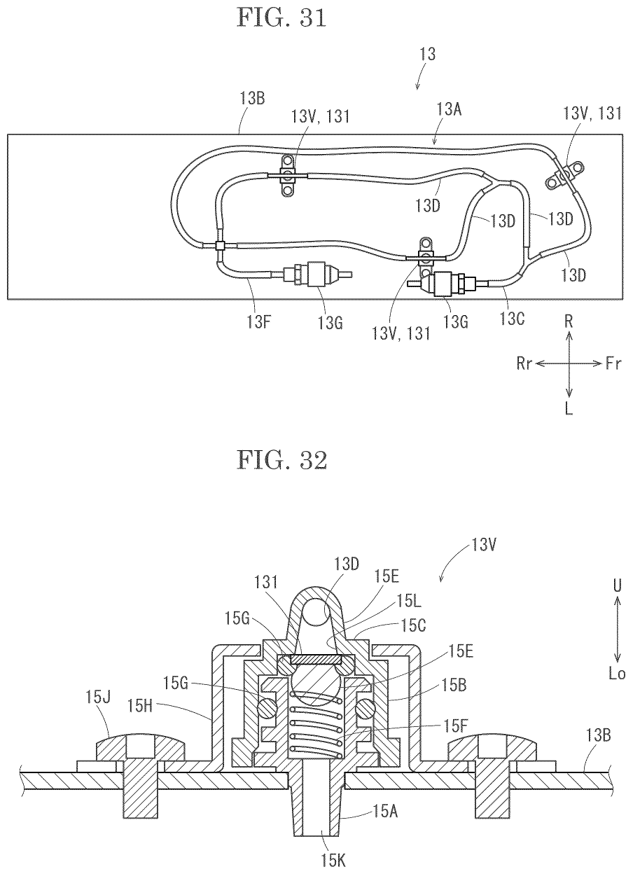

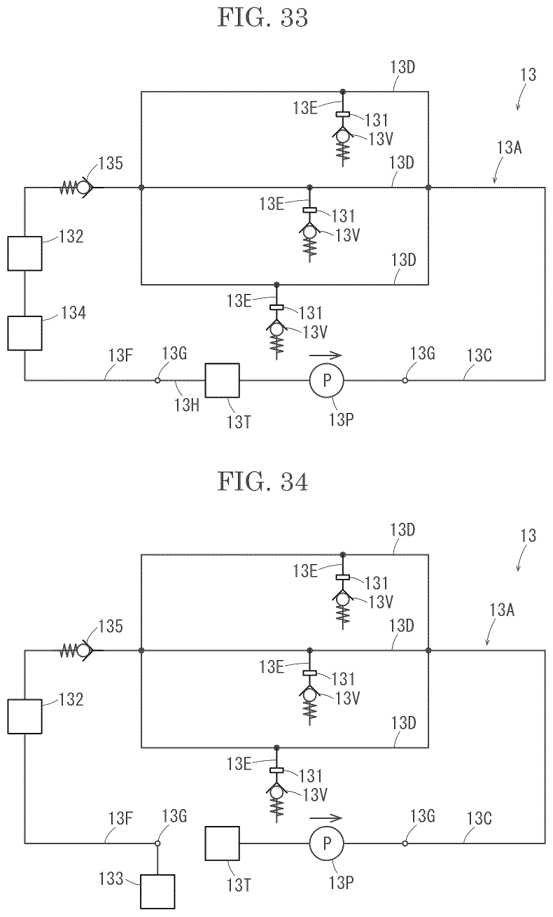

FIG. 31 is a plan view showing the cleaning liquid supply source 13. FIG. 32 is a sectional view showing the check valve 13V. FIG. 33 is a piping system diagram showing the cleaning liquid supply source 13. The cleaning liquid supply source 13 according to this embodiment includes a flow pass 13A, the pump 13P for supplying a liquid (for example, the cleaning liquid) to the flow pass 13A, and an opening/closing device 132 for opening/closing the flow pass 13A. The flow pass 13A includes a plurality of distribution flow passes 13D provided in parallel between the pump 13P and the opening/closing device 132. Each of the distribution flow passes 13D includes a branch flow pass 13E branched from the distribution flow pass 13D, a filter 131 for filtering the liquid flowing through the branch flow pass 13E, and the check valve 13V provided on the downstream side of the filter 131. In each of the distribution flow passes 13D, a liquid resistance of the filter 131 is larger than a release pressure of the check valve 13V and a liquid resistance of the distribution flow pass 13D when the flow pass 13A is opened by the opening/closing device 132. The details are as follows. Hereinafter, the upstream side and the downstream side refer to the upstream side and the downstream side in the supply direction of the cleaning liquid.

[Flow Pass] The flow pass 13A (see FIG. 31) is attached to the support plate 13B. The flow pass 13A includes three sections of a supply flow pass 13C, a plurality of parallel distribution flow passes 13D, and a recovery flow pass 13F in order from the upstream side. The distribution flow passes 13D are branched from the supply flow pass 13C and merged with the recovery flow pass 13F. A number of distribution flow passes 13D is equal to a number of the cleaning liquid supply members 41 (in this embodiment, three) provided in the wipe unit 32.

Couplings 13G are provided at both ends of the flow pass 13A. A relay flow pass 13H is provided between the two couplings 13G. That is, the flow pass 13A is formed in an annular shape as a whole. The relay flow pass 13H is provided with a tank 13T for storing the cleaning liquid and the pump 13P for supplying the cleaning liquid from the tank 13T to the flow pass 13A.

[Opening/closing Device] The recovery flow pass 13F is provided with the opening/closing device 132. The opening/closing device 132 may have any structure as long as it opens/closes the recovery flow pass 13F, and may be composed of, for example, an eccentric cam and a reaction plate facing each other across the recovery flow pass 13F, or may be a solenoid valve (not shown).

[Branch Flow Pass] Each of the distribution flow passes 13D is provided with the branch flow pass 13E branched from the distribution flow pass 13D. The branch flow pass 13E is provided with the filter 131 and the check valve 13V in order from the upstream side.

[Check Valve] The check valve 13V (see FIG. 32) includes an inner cylindrical portion 15A, an outer cylindrical portion 15B, a ceiling portion 15C, a ball 15E, and a spring 15F. The inner cylindrical portion 15A is housed inside the outer cylindrical portion 15B. The inner cylindrical portion 15A has a discharge port 15K. The ceiling portion 15C is integrated with the outer cylindrical portion 15B and closes the upper end portion of the outer cylindrical portion 15B. A space between the inner peripheral surface of the outer cylindrical portion 15B and the outer peripheral surface of the inner cylindrical portion 15A is sealed with an O-ring 15G. A space between the upper end portion of the inner cylindrical portion 15A and the ceiling portion 15C is sealed with the O-ring 15G. The spring 15F is arranged inside the inner cylindrical portion 15A. The ball 15E is pushed upward by the spring 15F and is pressed against the O-ring 15G between the inner cylindrical portion 15A and the ceiling portion 15C. A through-hole 15L penetrating in the upper-and-lower direction is provided in the center of the ceiling portion 15C. The branch flow pass 13E is connected to the through-hole 15L.

[Filter] The filter 131 is provided between the ceiling portion 15C and the ball 15E. The filter 131 is formed in a plate shape using nonwoven fabric, woven fabric, paper, a porous body or the like. The check valve 13V is fastened to the support plate 13B using a screw 15J through a fixing member 15H covering the outer cylindrical portion 15B.

In the above configuration, when the cleaning liquid is supplied to the supply member 41 of the cleaning liquid supply part 40 through the branch flow pass 13E, the control part 2 closes the recovery flow pass 13F by the opening/closing device 132. Then, a pressure in the branch flow pass 13E is increased, the check valve 13V is released, and the cleaning liquid is supplied through the check valve 13V. On the other hand, when the recovery flow pass 13F is opened by the opening/closing device 132, since a liquid resistance of the distribution flow pass 13D is lower than that of the branch flow pass 13E, the cleaning liquid flows along the distribution flow pass 13D and joins the recovery flow pass 13F. In this case, the cleaning liquid is not supplied to the branch flow pass 13E.

However, since there is an individual difference in a spring constant of the spring 15F of the check valve 13V, there is also an individual difference in a release pressure of the check valve 13V. In the conventional configuration in which the filter 131 is not provided, the cleaning liquid flows preferentially to the branch flow pass 13E having the check valve 13V whose release pressure is lowest, and the cleaning liquid hardly flows to the other branch flow pass 13E. Then, a supply amount of the cleaning liquid to the plurality of supply members 41 provided in the wipe unit 32 becomes uneven.

Therefore, in the present embodiment, the filter 131 is provided between the branch point of the branch flow pass 13E and the check valve 13V, and in addition, a liquid resistance of the filter 131 is larger than a release pressure of the check valve 13V. When the filter 131 of the same material and the same specification is used, a variation in the liquid resistance of the filter 131 is smaller than a variation in the release pressure of the check valve 13V, so that the pressure is increased substantially uniformly in the plurality of branch flow passes 13E. Since a pressure of the cleaning liquid passing through the filter 131 is larger than a release pressure of the check valve 13V, even if there is an individual difference in the release pressure of the check valve 13V, a uniform amount of the cleaning liquid is supplied through each check valve 13V.

A liquid resistance of the filter 131 is preferably three times or more of a release pressure of the check valve 13V. A liquid resistance of the filter 131 is preferably two times or more of a liquid resistance of the distribution flow pass 13D when the recovery flow pass 13F is opened by the opening/closing device 132.

[Defoaming Device] Preferably, the recovery flow pass 13F is preferably provided with a defoaming device 134. The defoaming device 134 may be configured to remove bubbles from the cleaning liquid by, for example, providing a gas-liquid separation membrane in a part of the recovery flow pass 13F and decreasing pressure of the outside of the gas-liquid separation membrane (not shown). Alternatively, the defoaming device 134 may be configured such that a liquid tank (a bubble trap) for temporarily storing the cleaning liquid is provided in the recovery flow pass 13F, and bubbles are discharged from the liquid level in the liquid tank into the atmosphere (not shown).

[Check Valve of Recovery flow pass] Preferably, a check valve 135 is provided in the recovery flow pass 13F. The check valve 135 has the same structure as the check valve 13V of the branch flow pass 13E, but the filter 131 is not provided.

Next, the operation of the cleaning liquid supply source 13 will be described. When the discharge port 15K of the check valve 13V is inserted into the intake port 53N of the supply member 41 in the pushed down state (see FIG. 20, FIG. 22 and FIG. 23A), the control part 2 closes the recovery flow pass 13F by the opening/closing device 132. At this time, a pressure in the recovery flow pass 13F is increased, but the check valve 135 is provided, so that a backflow of the cleaning liquid does not occur.

Next, the control part 2 drives the pump 13P to supply the cleaning liquid to the supply flow pass 13C. Then, a pressure in the distribution flow pass 13D increases, but since the recovery flow pass 13F is closed, the cleaning liquid flows from the distribution flow pass 13D into the branch flow pass 13E. Since a liquid resistance of the filter 131 is larger than a release pressure of the check valve 13V, the pressure increases uniformly in the plurality of branch flow passes 13E, and a uniform amount of the cleaning liquid is supplied through each check valve 13V. The control part 2 stops the pump 13P after driving the pump 13P only for a predetermined time.

Here, when the pump 13P is left in the stopped state, a release pressure of the check valve 13V and a pressure in the distribution flow pass 13D transition to an equilibrium state, and when the equilibrium state is broken by vibration or the like, the cleaning liquid leaks from the check valve 13V. Therefore, after the pump 13P is stopped, the control part 2 opens the recovery flow pass 13F by the opening/closing device 132 to lower the pressure in the recovery flow pass 13F. By this treatment, the leakage of the cleaning liquid from the check valve 13V can be prevented.

Next, the control part 2 drives the pump 13P while the recovery flow pass 13F is opened by the opening/closing device 132. This operation causes the cleaning liquid to circulate in the flow pass 13A and bubbles to be removed from the cleaning liquid by the defoaming device 134. Circulation of the cleaning liquid may be performed before the supply of the cleaning liquid or periodically.

The liquid supply device (the cleaning liquid supply source 13) according to the present embodiment described above includes the flow pass 13A, the pump 13P for supplying the liquid (the cleaning liquid) to the flow pass 13A, and the opening/closing device 132 for opening and closing the flow pass 13A. The flow pass 13A includes the distribution flow passes 13D provided in parallel between the pump 13P and the opening/closing device 132. Each of the distribution flow passes 13D includes the branch flow pass 13E branched from the distribution flow pass 13D, the filter 131 for filtering the liquid flowing through the branch flow pass 13E, and the check valve 13V provided on the downstream ide of the filter 131. A liquid resistance of the filter 131 in each of the distribution flow passes 13D is larger than a release pressure of the check valve 13V and a liquid resistance of the distribution flow pass 13D when the flow pass 13A is opened by the opening/closing device 132. According to this configuration, the liquid can be uniformly supplied from the plurality of check valves 13V.

Further, according to the liquid supply device according to the present embodiment, the tank 13T for supplying the liquid to the flow pass 13A through the pump 13P is provided, and the flow pass 13A is formed in an annular shape. According to this configuration, a consumption of the liquid can be decreased.

Further, according to the liquid supply device according to the present embodiment, the defoaming device 134 for removing bubbles from the liquid is provided in the flow pass 13A. According to this configuration, it is possible to suppress an insufficient supply of the liquid due to residual bubbles.

Further, according to the liquid supply device according to the present embodiment, the check valve 135 is provided between the branching point of the plurality of branch flow passes 13E and the opening/closing device 132. According to this configuration, when the flow pass 13A is closed by the opening/closing device 132, a backflow of the liquid can be prevented.

Further, the liquid supply device according to the present embodiment includes the control part 2 for controlling the pump 13P and the opening/closing device 132, the control part 2 drives the pump 13P in a state where the flow pass 13A is closed by the opening/closing device 132, stops the pump 13P, and then opens the flow pass 13A by the opening/closing device 132. According to this configuration, a leakage of the liquid due to vibration or the like can be prevented.

Further, according to the liquid supply device according to the present embodiment, the control part 2 for controlling the pump 13P and the opening/closing device 132 is provided, and the control part 2 drives the pump 13P in a state in which the flow pass 13A is opened by the opening/closing device 132. According to this configuration, the removal of bubbles can be promoted by the circulation of the liquid.

The inkjet recording apparatus 1 according to the present embodiment includes the inkjet head 12, the liquid supply device, and the maintenance device 30 for cleaning the inkjet head 12 by using the cleaning liquid supplied from the liquid supply device. With this configuration, the ink can be prevented from falling from the inkjet head 12.

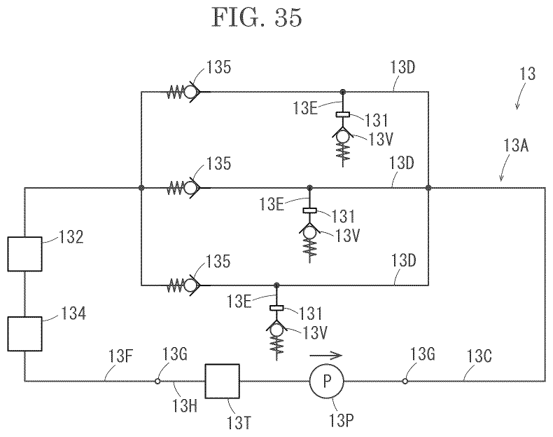

The above embodiment may be modified as follows.

[First Modified Example] FIG. 34 is a piping system diagram showing the cleaning liquid supply source 13. The liquid supply device according to the present modified example is provided with the tank 13T for supplying the liquid to the flow pass 13A through the pump 13P at the upstream end of the flow pass 13A, and a waste liquid tank 133 to which the liquid is discharged, at the downstream end of the flow pass 13A. In the present modified example, the couplings 13G are not connected by the relay flow pass 13H. The tank 13T and the pump 13P are connected to the upstream coupling 13G, and the waste liquid tank 133 is connected to the downstream coupling 13G. That is, the cleaning liquid flows along the one-way flow pass 13A from the tank 13T to the waste liquid tank 133. According to this modified example, the liquid can be uniformly supplied from the plurality of check valves 13V.

[Second Modified Example] FIG. 35 is a piping system diagram showing the cleaning liquid supply source 13. The liquid supply device according to the present modified example includes a check valve 135 in each of the distribution flow passes 13D. This configuration also prevents a backflow of the liquid when the flow pass 13A is closed by the opening/closing device 132.

1. A liquid supply device comprising:
a flow pass;
a pump which supplies a liquid to the flow pass; and
an opening/closing device which opens and closes the flow pass, wherein
the flow pass includes a plurality of distribution flow passes provided in parallel between the pump and the opening/closing device,
each of the distribution flow passes includes:
a branch flow pass which is branched from the distribution flow pass;
a filter which filters the liquid flowing in the distribution flow pass; and
a check valve provided on a downstream side of the filter, and
in each of the distribution flow passes, a flow resistance of the filter is larger than a release pressure of the check valve and a flow resistance of the distribution flow pass when the flow pass is opened by the opening/closing device.

2. The liquid supply device according to claim 1, comprising:
a tank which supplies the liquid to the flow pass via the pump, wherein
the flow pass is formed in an annular shape.

3. The liquid supply device according to claim 1, comprising:
a tank which is provided at an upstream end of the flow pass and supplies the liquid to the flow pass via the pump, and
a waste liquid tank which is provided at a downstream end of the flow pass and to which the liquid is discharged.

4. The liquid supply device according to claim 2, comprising:
a defoaming device which is provided in the flow pass and removes bubbles from the liquid.

5. The liquid supply device according to claim 1, comprising:
a check valve provided between branch points of the distribution flow passes and the opening/closing device.

6. The liquid supply device according to claim 5, comprising:
a check valve provided in each of the distribution flow passes.

7. The liquid supply device according to claim 1, comprising:
a control part which controls the pump and the opening/closing device, wherein
the control part drives the pump in a state where the flow pass is closed by the opening/closing device, stops the pump, and then opens the flow pass by the opening/closing device.

8. The liquid supply device according to claim 4, comprising:
a control part which controls the pump and the opening/closing device, wherein
the control part drives the pump in a state where the flow pass is opened by the opening/closing device.

9. An inkjet recording apparatus comprising:
an inkjet head;
the liquid supply device according to claim 1; and
a maintenance device which cleans the inkjet head using the liquid supplied from the liquid supply device.
